(19) United States
(12) Patent Application Publication
(10) Pub. No.: US 2024/0001874 A1
(43) Pub. Date: Jan. 4, 2024

(54) VEHICLE INCLUDING A ZONE ARCHITECTURE

(71) Applicant: Robert Bosch GmbH, Stuttgart (DE)

(72) Inventors: Jochen Pflueger, Muehlacker (DE); Manuel Warwel, Tamm (DE); Richard Schoettle, Oelbronn (DE); Viola Malena Herbrig, Ludwigsburg (DE); Achim Henkel, Stuttgart (DE); Alexander Fuchs, Fellbach (DE)

(21) Appl. No.: 18/255,544

(22) PCT Filed: Dec. 6, 2021
(86) PCT No.: PCT/EP2021/084342

§ 371 Date: Jun. 1, 2023

(30) Foreign Application Priority Data
Dec. 9, 2020 (DE) 10 2020 215 524.0

(51) Int. Cl. B60R 16/03; B60R 16/023

(52) U.S. Cl. CPC B60R 16/03; B60R 16/023

(57) ABSTRACT

A vehicle including a front region zone, a cabin right zone, a cabin left zone, and a rear region zone. Each zone includes a defined number of zone control units.

### FIELD

The present invention relates to a vehicle including a zone architecture.

### BACKGROUND INFORMATION

E/E architectures including distinctive linking according to vehicle domains are the state of the art, i.e., separate, usually star-shaped communication networks and tree-shaped on-board power supply system structures exist for each domain (chassis, drive, body (inside and outside)). The disadvantage is complex wiring or a complex cable harness.

### SUMMARY

The present invention relates to a novel architecture concept for the linking of components which are installed in a vehicle. Advantageously, according to the present invention, a distinction is made between the front region zone, cabin right zone, cabin left zone, and the rear region zone, each zone including a defined number of zone control units.

Advantageously, according to an example embodiment of the present invention, separate zone control units are implemented in the cabin and rear for safety-relevant consumers.

If the consumers for implementing vehicle functions are to be supplied via a QM network, separate zone control units are installed. As a result, safety-relevant ASIL consumers are reliably separated from one another via a safety-relevant on-board power supply system, and QM consumers are reliably separated from one another via a QM network, and the complexity is reduced by the zone architectures.

According to an example embodiment of the present invention, an energy source, which is designed as a DC/DC converter, is situated in the front zone. However, it is also possible for the energy source to be designed as a different embodiment which appears useful to those skilled in the art.

Advantageously, according to an example embodiment of the present invention, an electrical power distributor is situated in the front zone, which supplies the cabin right zone, cabin left zone, and the rear region zone with electrical energy. A reliable energy supply of the zones may advantageously be ensured in this way.

According to an example embodiment of the present invention, the front zone advantageously includes a separator which is designed as a vehicle electrical system switch. According to the present invention, the separator is able to separate the safety-relevant on-board power supply system from the QM network. In this way, a reliable on-board power supply system may be implemented.

Further advantages and advantageous embodiments may be derived from the description of the FIGURE and the FIGURE.

### BRIEF DESCRIPTION OF THE DRAWING

FIG. 1 shows a vehicle including a zone architecture according to an example embodiment of the present invention.

### DETAILED DESCRIPTION OF EXAMPLE EMBODIMENTS

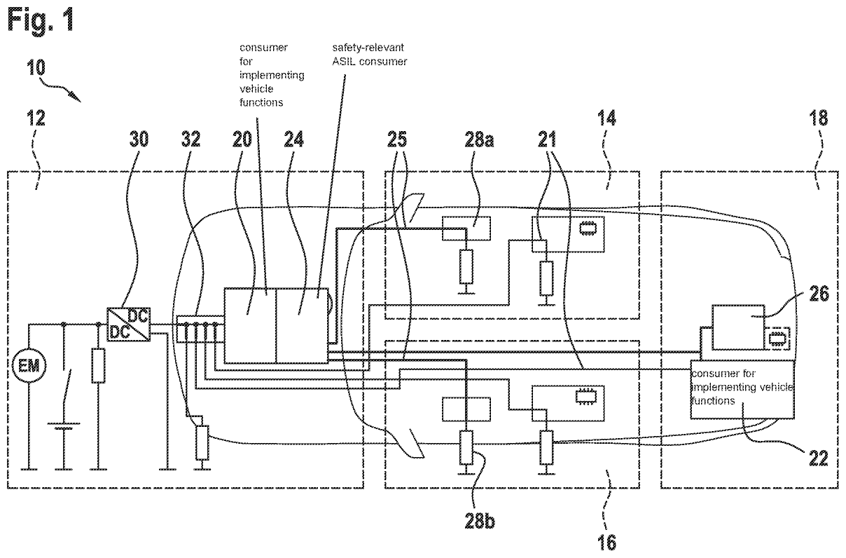

FIG. 1 shows a vehicle 10 including four defined zones in a simplified view. The following zones are visible:
front region zone 12
cabin right zone 14
cabin left zone 16
rear region zone 18

Furthermore, a number of zone control units is shown.

Consumers 20, 22 for implementing vehicle functions are situated in front zone 12 and rear region zone 18. The consumers for implementing vehicle functions 20, 22 are connected to one another via a QM network 21. Safety-relevant ASIL consumers 24, 26, 28a and 28b are connected to one another via a safety-relevant on-board power supply system 25. 28a and 28b are designed as power distributors in the process.

In the specific embodiment according to the present invention, an energy source 30 is situated in the front zone. Energy source 30 is a DC/DC converter. However, any other energy source which appears useful to those skilled in the art is possible.

It is also possible that energy source 30 is situated in a different zone, and not in front region zone 12.

An electrical power distributor 32 is situated in front zone 12. Electrical power distributor 32 may be implemented as a fuse holder including safety fuses or as a component including electronic semiconductor fuses. Electrical power distributor 32 supplies cabin right zone 14, cabin left zone 16, and rear region zone 18 with electrical energy.

Furthermore, a separator is present in the front zone. The separator is designed as a vehicle electrical system switch.

The separator is able to separate the safety-relevant on-board power supply system from the QM network. The front zone thus forms a so-called safety island.

However, it is also possible that a different zone is designed as the “safety island” and that the separator is accordingly situated in a different zone ECU.

In an alternative specific embodiment, the vehicle electrical system switch may also be implemented as an external component which is not integrated into a zone ECU.

The respective safety-relevant consumers 28 of the subordinate zones 14, 16, 18 are supplied via electronic switches from the safety-relevant network of the safety island. Power distributors 28a, 28b are each designed as a separate control unit. 28a and 28b may be implemented as a fuse box including safety fuses or as an intelligent component including electronic semiconductor fuses.

A further energy store is present within the safety-critical network, which is designed to ensure the availability of electrical energy even in the event of a failure of the primary energy source. The energy store may be designed as a double layer capacitor, as a flywheel energy store, or the like.

1-9. (canceled)

10. A vehicle, comprising:
a front region zone;
a cabin right zone;
a cabin left zone; and
a rear region zone;
wherein each of the zones includes a defined number of zone control units.

11. The vehicle as recited in claim 10, wherein the front region zone and the rear region zone include consumers for implementing vehicle functions.

12. The vehicle as recited in claim 11, wherein the consumers for implementing vehicle functions are connected to one another via a QM network.

13. The vehicle as recited in claim 10, wherein safety-relevant ASIL consumers are connected to one another via a safety-relevant on-board power supply system.

14. The vehicle as recited in claim 10, wherein an energy source is situated in the front region zone, the energy source being a DC/DC converter.

15. The vehicle as recited in claim 10, wherein an electrical power distributor is situated in the front region zone.

16. The vehicle as recited in claim 15, wherein the electrical power distributor supplies the cabin right zone, the cabin left zone, and the rear region zone with electrical energy.

17. The vehicle as recited in claim 12, wherein the front region zone includes a separator, the separator being a vehicle electrical system switch.

18. The vehicle as recited in claim 17, wherein safety-relevant ASIL consumers are connected to one another via a safety-relevant on-board power supply system, and wherein the separator is configured to separate the safety-relevant on-board power supply system from the QM network.
